(19) United States
(12) Patent Application Publication
(10) Pub. No.: US 2023/0148564 A1
(43) Pub. Date: May 18, 2023

(54) PEDAL ACTIVATED PET BOWL

(71) Applicants: Timothy Carlisle Roberts, Houston, TX (US); Sarah Louise Murphy, Houston, TX (US)

(72) Inventors: Timothy Carlisle Roberts, Houston, TX (US); Sarah Louise Murphy, Houston, TX (US)

(21) Appl. No.: 18/055,216

(22) Filed: Nov. 14, 2022

Related U.S. Application Data
(63) Continuation-in-part of application No. 29/866,425, filed on Sep. 12, 2022.
(60) Provisional application No. 63/279,134, filed on Nov. 14, 2021.

(51) Int. Cl. A01K 5/02; A01K 7/06

(52) U.S. Cl. CPC A01K 5/025; A01K 7/06

(57) ABSTRACT

A pedal activated pet dish includes a base; a bowl affixed to the base; a lid attached to the bowl by a hinge; and a pedal actuator mounted to the base. The base houses an opening apparatus connected to the lid. The pedal actuator is vertically slidable and is connected to the opening apparatus. When the pedal actuator is depressed, it causes the opening apparatus to lift the lid.

### CROSS-REFERENCE TO RELATED APPLICATION

This application claims the benefit of priority of U.S. provisional application No. 63/279,134, entitled “Make Sense Pet Feeder”, filed Nov. 14, 2021, and of U.S. application Ser. No. 29/866,425, entitled “Pet Bowl with Pedal Actuated Lid”, filed Sep. 12, 2022. The contents of both applications are herein incorporated by reference in their entireties.

### BACKGROUND OF THE INVENTION

The present invention relates to pet feeders and, more particularly, to a pedal activated pet bowl.

Currently available pet bowls leave the contents open for unwanted insects, rodents, and parasites to get into a pet's food and water. They do not adequately protect the contents. Containers that do adequately protect the contents do not offer easy access for the pet. No pet bowl has a lid and gives the pet means to access the contents by raising the lid, at least without electrical control.

As can be seen, there is a need for a pet bowl that protects food and water from contamination while giving the pet easy access to the contents.

### SUMMARY OF THE INVENTION

In one aspect of the present invention, a pedal activated pet dish, comprises a base having an opening means housed therein; a bowl affixed to the base; a lid hingedly attached to the bowl and movably attached to the opening means; and a pedal actuator mounted to the base in a vertically slidable configuration, connected to the opening means housed in the base such that the pedal actuator is operative to lift the lid when the pedal actuator is depressed.

The bowl may be used to keep pet food and water free from debris, insects, rodents, and parasites.

These and other features, aspects and advantages of the present invention will become better understood with reference to the following drawings, description, and claims.

### BRIEF DESCRIPTION OF THE DRAWINGS

FIG. 1 is a perspective view of a pedal activated pet bowl according to an embodiment of the present invention, shown in use;

FIG. 2 is a perspective view thereof, shown with the lid in a closed position;

FIG. 3 is a sectional view thereof, taken along line 3-3 of FIG. 2;

FIG. 4 is another sectional view thereof, illustrating activation of the pedal; and

FIG. 5 is another perspective view thereof, shown with the lid in an open position.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, one embodiment of the present invention is a pet bowl with a hinged lid, a base, and a pet actuated pad. The bowl is affixed to the base, the lid is hingedly attached to the bowl, and the pad extends from the base. The pad actuates opening means housed in the base to lift the lid when the pad is pressed.

The lidded bowl protects its contents, which are accessible to the pet by pressing the pad or pedal that opens the lid. The pedal may have an external horizontal planar surface, an internal surface, and a vertical wedge and a spacer with a platform extending from the internal surface.

The opening means may comprise a pulley system, a fixed (and moving) pivot hinge or joint, and/or electric components housed in the base. The pulley system may comprise multiple wheels with a filament threaded around them.

In some embodiments, the bowl may be used as follows. The pet presses the pad to open the lid. When the pad is pressed, the pulley system pulls the lid which pivots around the hinge to open the bowl.

The materials of manufacture are not particularly limited. For example, the material may be a plastic and the method of manufacture may be injection molding of plastic.

The size, shape, and configuration of the base, bowl, lid, and pedal are not particularly limited, provided that the pedal causes the lid to lift from the bowl.

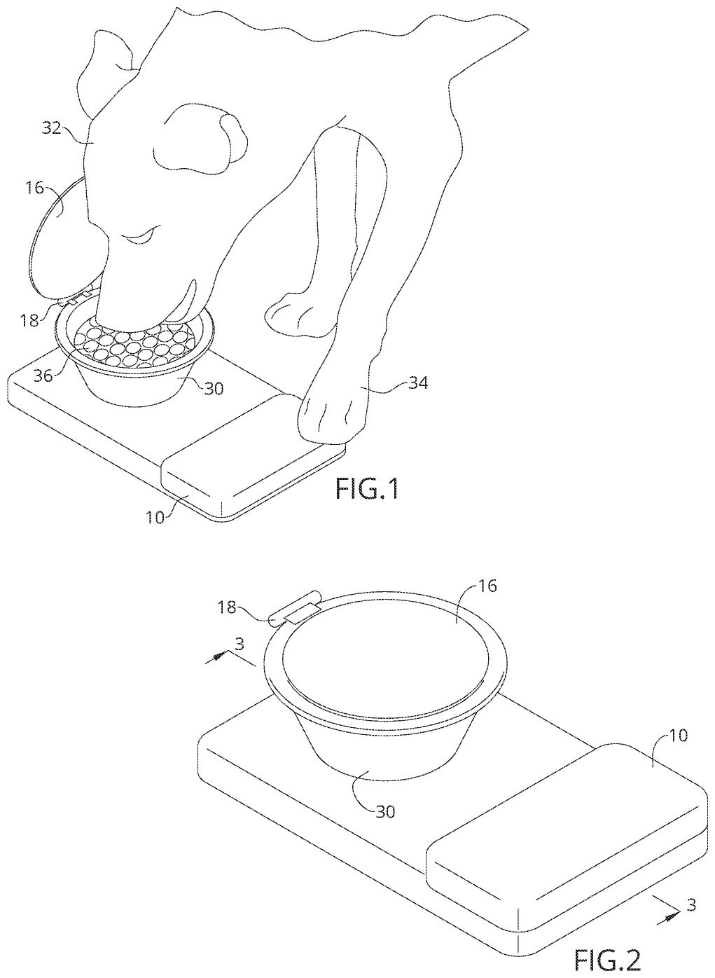

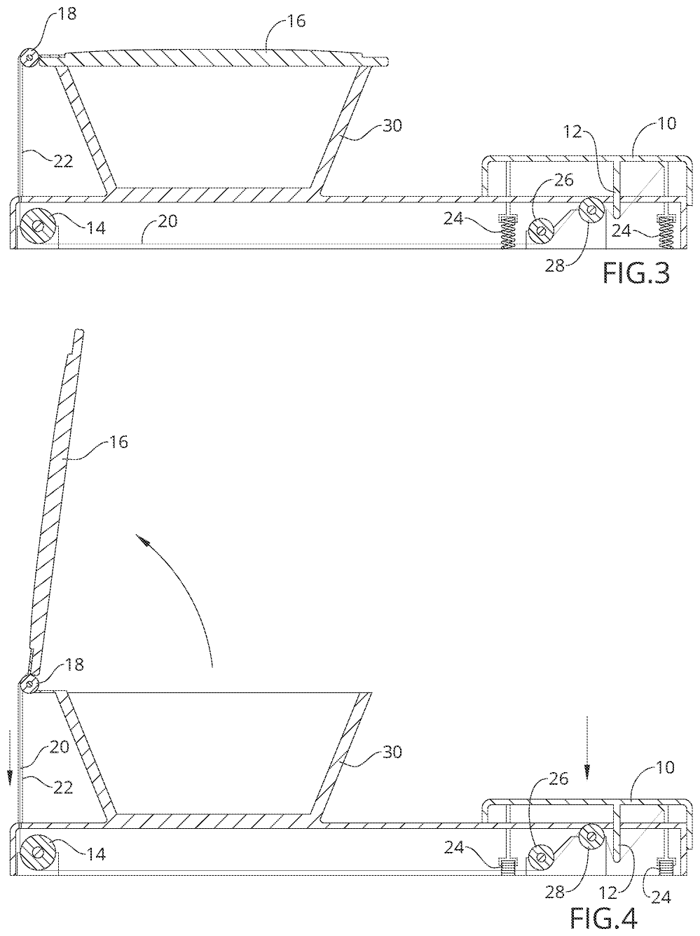

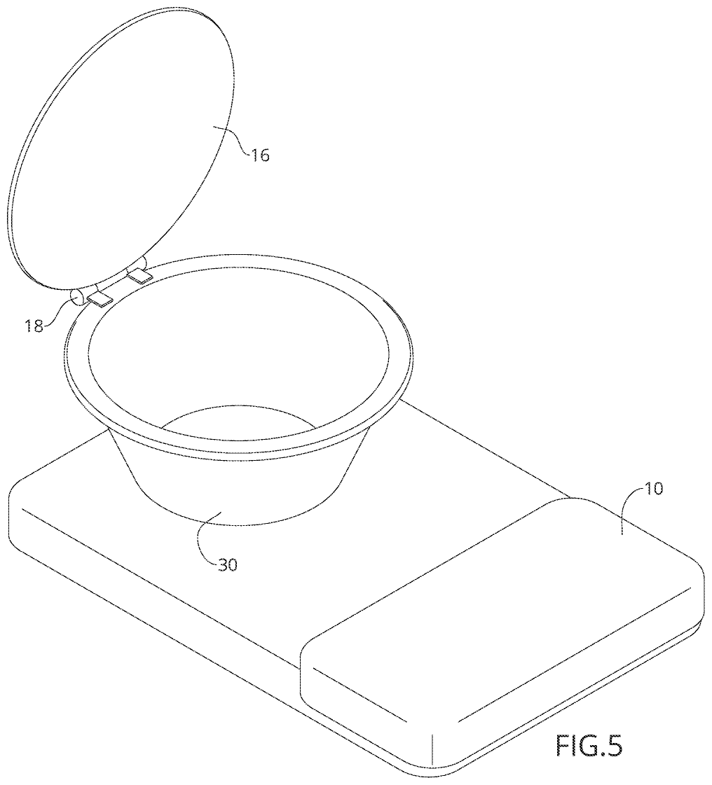

Referring to FIGS. 1 through 5, FIG. 1 illustrates a pedal activated pet bowl in use. The device comprises a bowl 30 with a lid 16 connected by way of a hinge 18 mounted to a base opposite a pedal 10. See also FIGS. 2 and 5. A dog 32 presses on the pedal 10 with its paw 34, raising the lid 16 on the bowl 30, and making the contents 36 accessible. The lid lifting means are shown in FIGS. 3 and 4. The pedal 10 has a vertical wedge 12 extending from its lower surface. When the pedal 10 is depressed, the wedge 12 presses a wire 20 extending from a spacer atop a spring 24 to a top surface of the lid 16. The wire 20 is threaded around a first wheel 26, a second wheel 28, a spool 14, and passes through a wire casing 22 to the hinge 18. Pressure on the wire 20 causes it to pull on the lid 16, raising it to an open position. The pedal 10 compresses springs 24 which return to their original position when pressure is removed from the pedal 10, returning the pedal 10 to its raised position and the lid 16 to its closed position.

It should be understood, of course, that the foregoing relates to exemplary embodiments of the invention and that modifications may be made without departing from the spirit and scope of the invention as set forth in the following claims.

What is claimed is:

1. A pedal activated pet dish, comprising:
a base having an opening means housed therein;
a bowl affixed to the base;
a lid hingedly attached to the bowl and movably attached to the opening means; and
a pedal actuator mounted to the base in a vertically slidable configuration, connected to the opening means housed in the base such that the pedal actuator is operative to lift the lid when the pedal actuator is depressed.

2. The pedal activated pet dish of claim 1, wherein the pedal actuator has an external horizontal planar surface and an internal surface with a vertical wedge extending perpendicularly therefrom, and wherein the opening means comprises a filament threaded around at least one wheel and affixed to a portion of the pedal actuator and to the lid, such that when the pedal actuator is depressed, the wedge presses the filament causing it to pull on the lid, raising the lid to an open position.

3. The pedal activated pet dish of claim 2, wherein the pedal actuator comprises a spacer extending perpendicularly therefrom, the spacer having a platform at an end opposite the internal surface; and
a spring positioned between an inner surface of the base and the platform, such that depressing the pedal actuator compresses the springs and that when pressure is removed from the pedal, the springs returning the pedal to its raised position and return the lid to its closed position.

4. The pedal activated pet dish of claim 2, wherein the at least one wheel comprises a first wheel, a second wheel, and a third wheel, and wherein the opening means further comprises a filament casing extending from the third wheel to the hinge, such that the first, second, and third wheels are configured to route the wire from the pedal actuator to the lid across the hinge.
